(19) United States
(12) Patent Application Publication
(10) Pub. No.: US 2018/0255806 A1
(43) Pub. Date: Sep. 13, 2018

(54) ANIMAL FOOD AND METHOD FOR PREPARING SAME

(71) Applicant: Robert Goldstein, Westport, CT (US)

(72) Inventor: Robert Goldstein, Westport, CT (US)

(21) Appl. No.: 15/981,678

(22) Filed: May 16, 2018

Related U.S. Application Data
(62) Division of application No. 15/017,258, filed on Feb. 5, 2016.

(51) Int. Cl. A23K 30/20; A23K 50/42; A23K 10/30; A23K 10/20; A23K 10/22

(52) U.S. Cl. CPC A23K 30/20; A23K 50/42; A23K 10/30; A23K 10/22; A23K 10/20

(57) ABSTRACT

A method to prepare an animal food by dehydrating animal meat, such as poultry, fish, beef, and lamb, and separately dehydrating a mixture of fruits and vegetables, each dehydration step using low heat and a high velocity air flow. Subsequently mix the dehydrated meat and the mixture of fruits and vegetables together to produce an animal food that complies or exceeds pet food standards established by the Association of American Feed Control Officials (AAFCO) and produce a complete and balanced animal food for pets at any life stage.

### CROSS-REFERENCE TO RELATED APPLICATIONS

This application is a divisional of, claims a priority benefit from, and incorporates herein by reference, U.S. patent application Ser. No. 15/017,258, filed Feb. 5, 2016.

### TECHNICAL FIELD

Applicant's disclosure relates to an animal food and method for producing such animal food.

### BACKGROUND

Commercial animal food for pets has been around for about 100 years. Most commercial animal food is highly processed and cooked at high temperatures. Furthermore, the ingredients include rendered and rejected meat by-products, milled grains, and synthetic vitamins containing a myriad of chemicals. Most animal food for pets sold in the U.S. is dry animal food, such as kibbles, wherein, the most commonly used process is extrusion/expansion, which subjects animal food ingredients to high temperatures that can degrades proteins, vitamins, enzymes, and antioxidants.

Pets fed on poor diets have shown symptoms attributed to low quality animal food, such as skin allergies, arthritis, kidney, liver, lung diseases, and cancer. Pet owners desire an animal food that is healthy for pets to consume and provides complete nutrition for them. Animal food for pets should be evaluated regarding its biological value of the food, which should contain highly digestible and high quality ingredients that are minimally processed to maintain optimal nutritional value and eliminates the threat of bacterial contamination.

### SUMMARY

Applicant's disclosure includes a method to prepare animal food by (1) dehydrating animal meat, such as poultry, fish, beef, and/or lamb, at about 160° F. and with a high velocity of airflow of at least 6000 feet per minute, (2) dehydrating a mixture of fruits and vegetables using the same dehydration procedure and parameters, and (3) mixing dehydrated meat, dehydrated fruits and vegetable along with food derived vitamins, minerals, enzymes, probiotics and other essentials nutrients in a composite to form the animal food. Further, in certain embodiments the method produces animal food that comprises about 82% by weight of the dehydrated meat and about 18% by weight of the dehydrated fruits and vegetables.

In certain embodiments, the method further comprises dehydrating a composite mixture of meat, fruits, and vegetables and mixing dehydrated meat, dehydrated mixture of fruits and vegetables, and dehydrated composite mixture to acquire natural vitamins and phytonutrients. In certain embodiments, the method produces animal food that comprises about 45% by weight of the dehydrated meat, about 10% by weight of the dehydrated fruits and vegetables, and about 45% by weight of the dehydrated composite mixture.

In certain embodiments, the method produces animal food that comprises highly digestible proteins and non-denatured antioxidants and phytonutrients from fruits and vegetables. Further, the method produces animal food that does not contain any genetically modified organisms (GMOs), neither adds nor forms any grains and any non-naturally-derived vitamins.

### BRIEF DESCRIPTION OF THE DRAWINGS

The invention will be better understood from a reading of the following detailed description taken in conjunction with the drawings in which like reference designators are used to designate like elements, and in which:

FIG. 1 is a schematic diagram of a prior art process of making animal food by extrusion;

FIG. 2 illustrates a method flowchart of a process of making the animal food with a first component of dehydrated meat and a second component of dehydrated fruits and vegetables; and

FIG. 3 shows a method flowchart of a process of making the animal food with a first component of dehydrated meat, a second component of dehydrated fruits and vegetables, and a third component of a dehydrated composite mixture of meat and fruits and vegetables.

### DETAILED DESCRIPTION

Applicant's disclosure is described herein in preferred embodiments in the following description with reference to the Figures, in which like numbers represent the same or similar elements. Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

The described features, structures, or characteristics of Applicant's disclosure may be combined in any suitable manner in one or more embodiments. In the following description, numerous specific details are recited to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

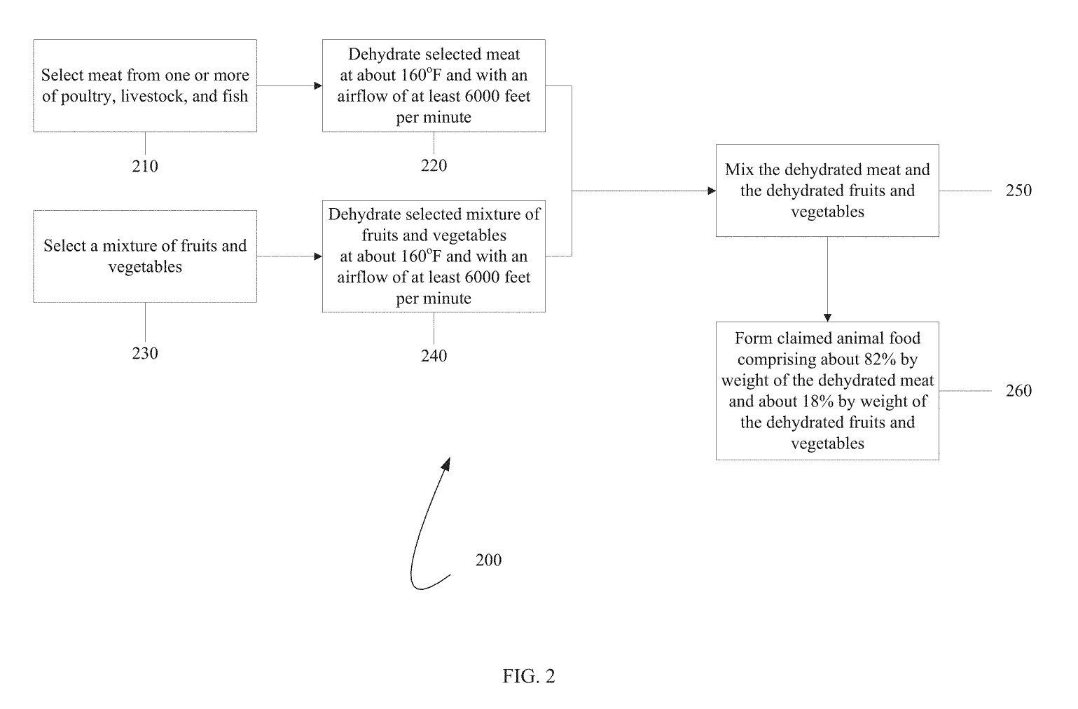

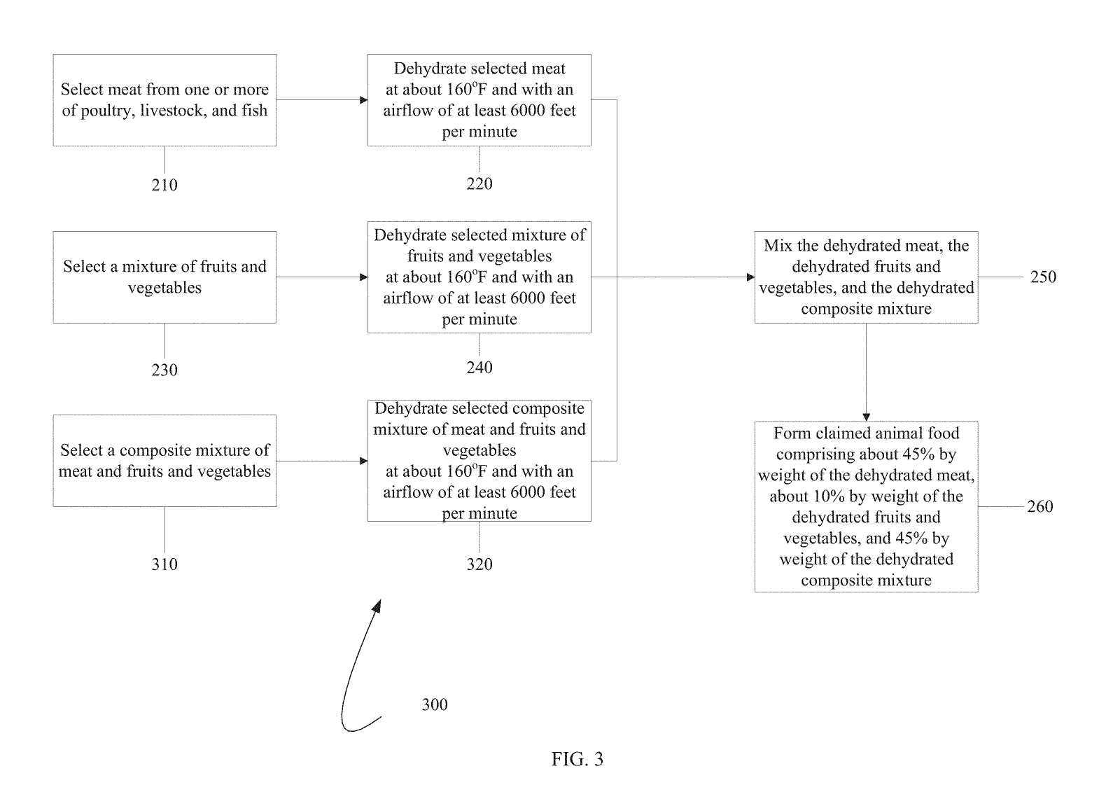

The schematic flow chart diagrams are generally set forth as logical flow chart diagrams (e.g., FIGS. 2 and 3). As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flowchart, they are understood not to limit the scope of the corresponding method (e.g., FIGS. 2 and 3). Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

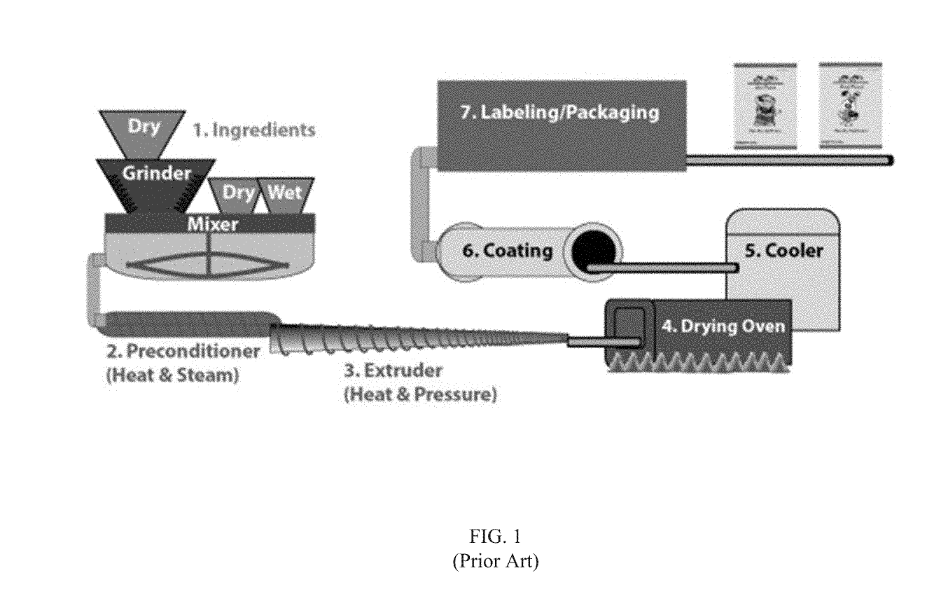

Applicant has developed a method for producing animal food for pets without using extrusion, a most commonly utilized method for making dry animal food for pets. FIG. 1 illustrates a prior art extrusion process of making animal food. First, all ingredients, such as by-products of meat, poultry, seafood, feed grains, soybean meal, gelling agents, and etc., are brought together in a mixer. Dry ingredients are grounded before mixing with wet ingredients. After mixing, dry and wet ingredients form a moist dough. Subsequently, the dough is heated in a preconditioner and pushed forward into an extruder comprising at least one heated spiral shaped screw, where the primary cooking phase for dry extruded pet products occurs and the dough is heated at about 400° F. The dough is cooked under intense heat and pressure continuously as it moves toward the open end of the extruder. At the open end of the extruder, the cooked and hot dough passes through a shaping die and knit where the small pieces expand rapidly into kibbles once they are under ambient air pressure. Further, the kibbles are dried in an oven until their moisture content is low enough to make them shelf stable like any other baked goods, such as a cookie or a cracker. Once the kibbles reach the desired dryness, they are moved into a cooler. After the cooling phase is complete, the kibbles may be sprayed with a coat of flavor enhancer. Lastly, the kibbles are packaged to meet the weight advertised on the label of the packages.

The prior art commercial extrusion process, as a thermomechanical treatment, produces several chemical and physical alterations to the raw ingredients in extruded animal food and changes the digestibility and utilization of the extruded products. The high temperature and high-pressure extrusion process causes thermal decomposition of some proteins. Depending on the exposure time to high drying temperatures (320-392° F.), fragments of degraded proteins can be found in the extruded animal food and are toxic and deleterious to animals. Studies have shown that at high drying temperatures lysine (an essential amino acid) damages occur with reactive lysine decreasing faster compared to total lysine. The free c-amino group of lysine can react with the carbonyl group of other compounds such as reducing sugars. The formed complex, which is called Maillard complex, cannot be utilized by animals for the most part. Proline-derived moieties in proteins are also adversely affected by the 400° F. temperature used in prior art extrusion process.

Further, this thermomechanical treatment causes protein denaturation in all ingredients, which involves the disruption and possible destruction of both the secondary and tertiary protein structures. Denaturation disrupts the normal alpha-helix and beta sheets in a protein and uncoils it into a random shape. High heat can be used to disrupt hydrogen bonds and non-polar hydrophobic interactions. This occurs because heat increases the kinetic energy and causes the molecules to vibrate so rapidly and violently that the hydrogen bonds are disrupted.

Denaturation occurs because the bonding interactions responsible for the secondary structure (hydrogen bonds to amides) and tertiary structure are disrupted. In tertiary structure there are four types of bonding interactions between “side chains” including: hydrogen bonding, salt bridges, disulfide bonds, and non-polar hydrophobic interactions. The denaturation of protein by high heat makes the absorption of the proteins and required amino acids more difficult for pets because the denatured proteins are harder for pets to digest and assimilate. Also, denatured proteins formed by high heat can cause pets to be more susceptible to allergic reactions because the animal immune system may not recognize the altered protein structures, which further causes allergic reactions.

Further, the high heat of extrusion destroys vitamin A, vitamin E, vitamin B, etc. The percentage of vitamin loss from extrusion can vary from 4% loss of vitamin B1 to about 65% loss of vitamins A and C. As described herein above, raw ingredients used in prior art dry animal food are often of low quality and they themselves may also be deficient in these essential nutrients.

Moreover, the high temperature and high pressure extrusion process causes starch gelatinization, which is a process of breaking down the intermolecular bonds of a starch molecule in the presence of water and heat, allowing the hydrogen bonding sites (the hydroxyl hydrogen and oxygen) to engage more water. Dry animal food normally contains about 30% to 40% percent starch, which is essential for making dry animal food because starch binds the ingredients together. Pets who consuming high levels of starch and carbohydrates often experience insulin and glucose response rate problems.

Additionally, the extrusion process may inactivate nutritionally active factors (NAFs). The ingredients used in dry animal food, in particular grain legumes, contain undesirable nutritionally active factors (NAFs) that interfere with digestion and absorption of nutrients.

FIG. 2 summarizes one embodiment of Applicant's process of forming an animal food for pets. In Step 210, the method selects meat from poultry, livestock, and/or fish. Poultry comprises chicken, turkey, duck, quail, goose, pheasant, etc. Livestock comprises cattle, deer, goat, sheep, pig, rabbit, etc. Fish comprises salmon, cod, sea bass, carp, catfish, flounder, etc. In certain embodiments, according to different embodiments of Applicant's pet food and method, one or more kinds of meat are selected.

For example, certain formulations comprise turkey. Other formulations comprise turkey and salmon. Yet other formulations comprise turkey, beef, and salmon.

All animals from which the meat product derives are raised locally on farms that treat the animals humanely. Factory farmed animals or animals imported from oversees are not utilized in Applicant's process. Only organic and natural wholesome cuts of meat are utilized in the current process, which does not include by-product ingredients, such as carcass, organs, blood, etc. As used herein, the term “organic” is defined by the U.S. Department of Agriculture's (USDA) National Organic Program (NOP) as “produced through approved methods that integrate cultural, biological, and mechanical practices that foster cycling of resources, promote ecological balance and conserve biodiversity. Synthetic fertilizers, sewage sludge, irradiation, and genetic engineering may not be used.”

In Step 220, the selected meat of Step 210 is dehydrated at about 160° F. while employing a high velocity airflow of at least 6000 feet per minute. As used herein, the term “about” refers to that the dehydrating temperature is within a 10% difference of 160° F. In certain embodiments, before the dehydration step 220, the selected meat is cut into pieces with suitable sizes that are convenient for the dehydrating process. Applicant's dehydration process removes moisture from food at a low temperature thereby increasing the shelf life without sacrificing the nutrients that are often destroyed with the high heat of extrusion.

Applicant's dehydration process also allows the food to be naturally preserved without the need for harsh chemical antioxidants, which may have adverse health benefits for pets. Dehydrated food does not require refrigeration and has a shelf life of 18 months to 2 years. The dehydrating temperature used in Applicant's method is high enough to kill all harmful bacteria, such as Salmonella, Listeria, and E. Coli, possibly contained in the selected meat, whereas the same dehydrating temperature is low enough not to denature proteins or deactivate vitamins in the selected meat, therefore, making non-denature protein more digestible for pets.

In Step 230, the method selects a mixture of fruits and vegetables to make an animal food for pets. The mixture of fruits and vegetables are locally sourced and not imported from overseas. Further, the mixture of fruits and vegetables are organic and do not contain any GMOs.

In Step 240 the method uses the same dehydration procedure and parameters for the mixture of fruits and vegetables, which are dehydrated by separately from the selected meat from step 230. In certain embodiments, the mixture of fruits and vegetables are dehydrated at about 160° F. and employing a high velocity of airflow at least 6000 feet per minute at the same time. As used herein, the term “about” refers to that the dehydrating temperature is within a 10% difference of 160° F. The dehydrating temperature is high enough to kill all harmful bacteria, such as Salmonella, Listeria, and E. Coli, possibly contained in the mixture of fruits and vegetables; whereas the same dehydrating temperature is low enough not to denature proteins or deactivate vitamins. The low dehydrating temperature is also able to retain natural mineral, antioxidants, and phytonutrients contained in the mixture of fruits and vegetables.

In certain embodiments, after completing the dehydration of the selected meat and the mixture of fruits and vegetables separately, the dehydrated meat and dehydrated mixture of fruits and vegetables are grounded into pieces with suitable sizes that are convenient for packaging and feeding, but at the same time, retain the likeness of “real” food. In some embodiments, the ground dehydrated meat and the mixture of fruits and vegetables are mixed together to form a complete and balanced animal food for pets. In certain embodiments, the ground dehydrated meat comprises about 82% by weight and the mixture of fruits and vegetables is about 18% by weight. As used herein, the term “about” refers to that the percentage of dehydrated meat or dehydrated mixture of fruits and vegetables is within about a 10% difference of 82% by weight or 18% by weight.

Referring to FIG. 3, Steps 210, 220, 230, and 240 are described hereinabove. In Step 310, the method selects a composite mixture of meat and fruits/vegetables to add additional natural vitamins to the final animal food product. The composite mixture of meat and fruits/vegetables is dehydrated at about 160° F. and employing a high velocity of airflow of at least 6000 feet per minute at the same time. As used herein, the term “about” refers to that the dehydrating temperature is within a 10% difference of 160° F. The dehydrating temperature is high enough to kill all harmful bacteria, such as Salmonella, Listeria, and E. Coli, possibly contained in the composite mixture; whereas the same dehydrating temperature is low enough not to denature proteins or vitamins.

The low dehydrating temperature is also able to retain natural mineral, antioxidants, and phytonutrients contained in the composite mixture. All animals from which the meat in the composite mixture comes are raised locally on farms that treat the animals humanely. The meat used in the composite mixture has to meet the same requirements as the meat selected in step 210 and the mixture of fruits and vegetables used in the composite mixture has to meet the same requirements as the mixture of fruits and vegetables in step 230.

In certain embodiments, the dehydrated composite mixture is grounded into small pieces of suitable sizes, which allow for convenient packaging and retaining the likeness of real food. The dehydrated composite mixture is mixed together with the dehydrated meat and the dehydrated mixture of fruits and vegetables to form the complete and balanced animal food for pets that meets or surpasses all the federal and state requirements for animal food. The percentage of the each component is calculated and confirmed by laboratory analysis to make sure that the amount of proteins, fat, fiber, carbohydrates, vitamins, and minerals in each component, when blended together at these percentages, resulted in a food that exceeds all nutritional requirements set by the Association of American feed Control Officials (AAFCO) to be labeled as a complete and balanced food for all live stages of pets. In certain embodiments, the component of the dehydrated meat is about 45% by weight, the component of the dehydrated mixture of fruits and vegetables is about 10% by weight, and the component of the composite mixture is about 45% by weight. As used herein, the term “about” refers to that the percentage of each component is within a 10% difference of its corresponding percentage by weight.

The composite mixture of meat and fruits and vegetables adds additional natural vitamins, non-denatured antioxidants, and non-denatured phytonutrients to the final animal food product. During Applicant's process, synthetic vitamins are added to the final animal food product only as needed to meet the requirements of AAFCO. Further, Applicant's process does not produce any non-naturally derived vitamins.

In certain embodiments, Applicant's process is carried out and the final animal food product is manufactured in a human food facility, which is certified by the U.S. Department of Agriculture (USDA) and Food and Drug Administration (FDA) and complies with human food production standards. In other embodiments, due to low heat in Applicant's process, all three components are minimally processed to eliminate harmful bacteria and to retain optimal nutritional value. Proteins, vitamins, antioxidants, and phytonutrients in selected meat and fruits and vegetables are maximally protected from denaturing and other chemical reactions that change structures and properties thereof. As a result, the final animal food product comprises highly digestible proteins. In further embodiments, the final animal food does not comprise any grains, any GMOs, or any non-naturally-derived vitamins.

In certain embodiments, the percentage of the each component can be adjusted to meet special needs of pets at different stages of their lives or any medical requirements. For example, the percentage of protein by weight in the final animal food product increases for pets during their growth or reproduction stages and decreases for aging pets compared to for pets during their adult maintenance stages. Further, the percentages of proteins, carbohydrates, and fat can be adjusted to meet weight loss needs for some pets.

In certain embodiments, the dehydrated selected meat and fruits and vegetables look, feel, and feed like real food compared to freeze dried animal food or kibbles, which may be helpful to certain pets that are choosy about their food. In some embodiments, the final animal food product for pets retains about 15-18% water by weight after the dehydration process, which increases palpability and is healthy for animals to ingest food containing a balanced amount of water. As described herein, “about” is used to indicate that the weight percentage of water retained in the final product varies in a difference of 5%.

While the preferred embodiments of the present invention have been illustrated in detail, it should be apparent that modifications and adaptations to those embodiments may occur to one skilled in the art without departing from the scope of the present invention.

We claim:

1. A method to prepare animal food comprising:
dehydrating meat selected from one or more of turkey, beef, lamb, chicken, and fish using a dehydration temperature of about 160° F. and an airflow of at least 6000 feet per minute, wherein said dehydration temperature does not deactivate proteins, vitamins, and antioxidants disposed within a dehydrated meat;
dehydrating a mixture of fruits and vegetables using a dehydration temperature of about 160° F. and an airflow of at least 6000 feet per minute, wherein said dehydration temperature does not deactivate proteins, vitamins, and antioxidants disposed within said dehydrated fruits and vegetable mixture; and
forming said animal food by mixing said dehydrated meat and said dehydrated mixture of fruits and vegetables.

2. The method of claim 1, wherein said animal food, comprises:
about 82 percent by weight of said dehydrated meat;
about 18 percent by weight of said dehydrated fruits and vegetables.

3. The method of claim 1, further comprising:
forming a composite mixture of dehydrated meat and said dehydrated fruits and vegetables using said 160° F. dehydrating temperature; and
forming said animal food by mixing said dehydrated meat, said dehydrated mixture of fruits and vegetables, and said dehydrated composite mixture, wherein no non-natural vitamins are added to said animal food.

4. The method of claim 3, wherein said animal food comprises:
about 45 percent by weight of said dehydrated meat;
about 10 percent by weight of said dehydrated fruits and vegetables; and
about 45 percent by weight of said dehydrated composite mixture.

5. The method of claim 4, wherein said animal food comprises highly digestible proteins.

6. The method of claim 5, wherein said animal food comprises non-denatured antioxidants and phytonutrients derived from vegetables and fruits.

7. The method of claim 6, wherein said animal food does not comprise any genetically modified organisms.

8. The method of claim 7, wherein said method does not form any non-naturally-derived vitamins.

9. The method of claim 8, wherein said animal food does not comprises any grains.

10. The method of claim 1, wherein said animal food is manufactured in a human food facility certified by the U.S. Department of Agriculture (USDA) and Food and Drug Administration (FDA) and complies with human food production standards.

11. The method of claim 10, wherein said animal food complies or exceeds pet food standards established by the Association of American Feed Control Officials (AAFCO).
